(19) United States
(12) Patent Application Publication
(10) Pub. No.: US 2008/0195678 A1
(43) Pub. Date: Aug. 14, 2008

(54) METHODOLOGIES AND ANALYTICS TOOLS FOR IDENTIFYING POTENTIAL PARTNERING RELATIONSHIPS IN A GIVEN INDUSTRY

(75) Inventors: YING CHEN, SAN JOSE, CA (US); JEFFREY THOMAS KREULEN, SAN JOSE, CA (US); LARRY LEE PROCTOR, COPPELL, TX (US); JAMES J. RHODES, LOS GATOS, CA (US); WILLIAM SCOTT SPANGLER, SAN MARTIN, CA (US)

Correspondence Address: SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 11/674,590

(22) Filed: Feb. 13, 2007

(51) Int. Cl. G06F 17/30; G06F 7/00

(52) U.S. Cl. 707/205; 707/7; 707/E17.001; 707/E17.014

(57) ABSTRACT

Disclosed is a method of identifying partnering potential by: assembling a set of target patents representative of an industry of interest; building a dictionary of text feature entries; generating a set of text feature clusters; creating one or more contingency tables for assignees; and deriving an indication of partnering potential between the first assignee and the second assignee by comparing the values for each category for each assignee in each contingency table.

### BACKGROUND OF THE INVENTION

The present invention relates generally to the field of online analytic processing of data and, in particular, to patent and web-related analytics tools and methodologies for assisting in the identification of potential partnering relationships in a given industry.

Modern business intelligence routinely makes extensive use of customer and transactional data obtained from databases stored in data warehouses. Such business intelligence may typically be obtained by posing an analytical search and/or query to one or more associated relational databases. Intellectual property (IP) intelligence, in particular, may be critical to the competitive advantage of a business entity. The business entity may seek to maximize the value of its IP by cross-licensing relationships (e.g., partnerships) for the set of patents and other IP that a business entity may own.

In the current state of the art, however, the process of identifying licensee markets can be time-consuming and ineffective. For example, conducting a search via the Internet may require multiple labor-intensive and time-consuming sessions. Moreover, the search results may require further manual processing to yield an output that may or may not be of value to the interested business entity.

As can be seen, there is a need for better methodologies and tools dedicated to the identification of cross-licensing markets.

### SUMMARY OF THE INVENTION

One embodiment of the present invention is a method for use with a set of intellectual property documents related to an industry of interest; the method comprising: classifying the intellectual property documents by assignee, creating categories for the documents, the categories identified by terms associated with the industry of interest, each of the intellectual property documents assigned to one of the categories, and constructing a contingency table that includes a listing of assignees for each of the categories, the listing for identifying assignees having interests in complementary ones of the categories.

Another embodiment of the present invention is a method for use with a set of patents related to an industry of interest, the method comprising: classifying the patents by assignee, creating for the patents categories based on features, wherein the features include at least one of words, phrases, structured values, and annotations found in the patents, and wherein the categories include particular ones of the features correlated with respective patent assignees, and comparing the patent assignees and the categories to identify those of the patent assignees having complementary portfolios that are substantially non-overlapping with respect to the categories.

Another embodiment of the present invention is a method of identifying partnering potential comprising the steps of: assembling a set of target patents, each of the target patents representative of an industry of interest, building a dictionary of text feature entries based on text feature terms occurring in the target patents, generating a set of text feature clusters, each of the text feature clusters associated with one of the text feature terms and having a text feature cluster size, the text feature cluster size representative of the number of target patents meeting at least one predefined criterion, creating a first contingency table for a first assignee, the first contingency table including a first subset of the text feature clusters, each of the text feature clusters in the first subset having a corresponding first numerical entry representative of the number of target patents meeting the predefined criterion and assigned to the first assignee, creating a second contingency table for a second assignee, the second contingency table including a second subset of the text feature clusters, each text feature cluster in the second subset having a corresponding second numerical entry representative of the number of target patents meeting the predefined criterion and assigned to the second assignee, and deriving an indication of partnering potential between the first assignee and the second assignee by comparing the first contingency table and the second contingency table.

Another embodiment of the present invention is a method for use with a set of assignee patents, each of the assignee patents related to an industry of interest; the method comprising: creating a first feature space for a first subset of assignee patents related to a first assignee, creating a second feature space for a second subset of assignee patents related to a second assignee, and comparing the first feature space to the second feature space to provide an indication of partnering potential between the first assignee and the second assignee.

Still another embodiment of the present invention is a computer program storage device readable by machine, tangibly embodying a program of instructions executable by the machine to perform a method for use with a set of target documents using one or more assignees, each of the target documents related to an industry of interest, where the method comprises: analyzing each of the target documents to derive a count of occurrences of assignees in each of the target documents, creating an assignee feature space based on assignee data extracted from the set of target documents, partitioning the assignee feature space into a plurality of categories based on at least one of the words or phrases appearing in the target patents, and applying domain expertise to selectively delete and merge at least one of the plurality of categories, and to create new categories.

A further embodiment of the present invention is a computer program product comprising a computer usable medium including a computer readable program, wherein when executed on a computer the computer readable program causes the computer to: identify an industry of interest, given a first set of companies that are representative of an industry, extract from a database a first set of intellectual property documents listing the first set of companies as assignees, analyze text fields in the extracted first set of intellectual property documents to identify terms therein associated with the industry of interest, retrieve a second set of intellectual property documents using the terms associated with the industry of interest, identify a second set of companies by analyzing text fields in the second set of intellectual property documents, retrieve a third set of intellectual property documents, the third set of intellectual properties having as assignees the second set of companies, and assemble the set of target patents by merging the first, second, and third sets of intellectual property documents.

These and other features, aspects and advantages of the present invention will become better understood with reference to the following drawings, description and claims.

### BRIEF DESCRIPTION OF THE DRAWINGS

FIG. 1 is a diagrammatical illustration of a system for identifying partnering potential data including a data warehouse, analytics tools, and domain knowledge input, in accordance with the present invention;

FIG. 2 is a flow diagram illustrating one method of operation for the system of FIG. 1;

FIG. 3 is a diagram illustrating one embodiment, in accordance with the present invention, of a contingency table including a plurality of assignees; and

FIG. 4 is a diagram illustrating a modified version of the contingency table of FIG. 3 showing entries for two assignees.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In general, elements of the present invention provide a method for analyzing predefined subject matter in a patent database in which the method functions to incorporate the inputs of one or more domain experts as the process executes. The process may include the use of keywords and searching through structured fields and unstructured fields to automatically create a feature space with numeric vectors, with the feature space being used to create taxonomies based on domain knowledge.

The present state of the art does not provide for the incorporation of domain knowledge into the process of developing a taxonomy, and does not provide for invoking expert input before conducting an analysis. In contrast, the disclosed method functions to enable domain experts to both generate and refine taxonomies, to capture domain knowledge before conducting an analysis, to compare companies to categories created via clustering and/or via one or more keywords; and to use a contingency analysis to identify potential partnering or cross licensing opportunities by matching companies with complementary portfolios.

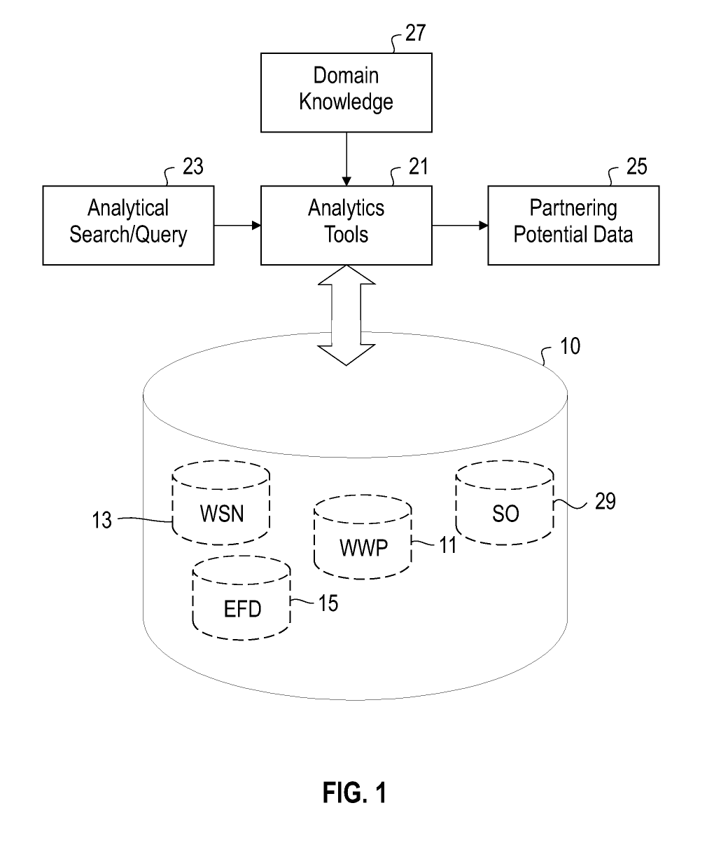

There is shown in FIG. 1 a data warehouse 10 which may comprise, in particular, databases useful in intellectual property analysis such as: a worldwide patent (WWP) database 11; a web, scientific, and news (WSN) database 13; and a financial (EFD) database 15 (e.g., Edgar financial data). The data warehouse 10 may also contain information about the documents comprising the worldwide patent database 11; the web, scientific, and news database 13; and the financial (FD) database 15. A set of analytics tools 21 may access the data warehouse 10 to perform a number of functions, including: extracting patents and related documents, automatically classifying patents, performing contingency analysis, and analyzing various relationships among patents and companies, as described in greater detail below.

An analytical search/query 23 may be placed to the data warehouse 10 by a database user interested in, for example, identifying cross-license markets in a particular industry, here broadly denoted as a partnering potential data output 25. As explained in greater detail below, domain knowledge 27 provided by domain experts may be applied to execute or enhance one or more of the functions performed by the analytics tools 21. For example, a process of analyzing licensing relationships among patents and companies may invoke both the expertise of an individual skilled in the technology of document classification and the expertise of a domain expert skilled in the art of licensing negotiations. Knowledge acquired as a result of the functions performed by the analytics tools 21 and by the domain experts may be written out to a string representation in the data warehouse 10 as a serialized object (SO) 29. Information in the serialized object 29 may be permanently saved and made available for sharing by other users.

In an exemplary embodiment, the analytics tools 21 may initiate an “investigate” phase in which the analytics tools 21 may (i) use a search tool to identify a set of companies active in an industry of interest; (ii) retrieve patents and other related materials describing technology and products owned by respective companies; and (iii) convert patents and company documents into numeric vectors corresponding to word, feature, and structured information content found in the respective documents.

Subsequently, in a “comprehend” phase, the analytics tools 21 may use a document classification technology, or taxonomy generation technology, to classify the selected patents into appropriate categories using a numeric vector space and a feature space created for the retrieved patents and other related materials. The document classification technology may use an interactive clustering of the feature space so as to assist a domain expert to refine the feature space for the combined company patents, if desired. This may be followed by an “examine” phase in which a contingency method may be used to compare the taxonomy to the assignees, such as comparing patent taxonomy classes with assignees, a process which may lead to the discovery of potential partnership or cross-licensing opportunities.

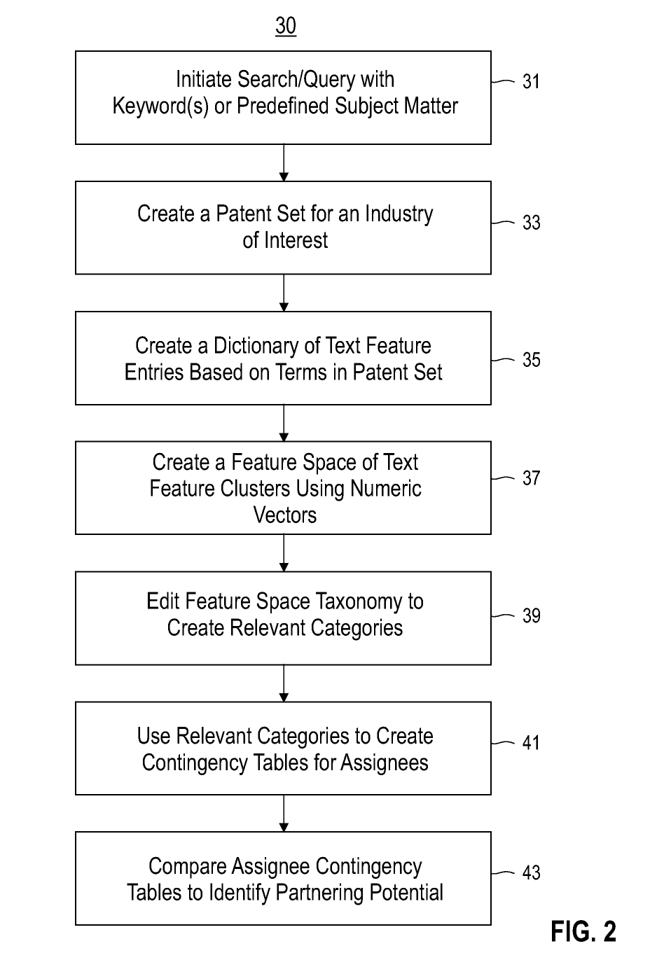

A general description of the method of the present invention can be provided with additional reference to a flow diagram 30, in FIG. 2. The search/query 23 may be initiated using one or more keywords and/or predefined subject matter, at step 31. As understood in the relevant art, a “search” may include entering selected words or text and retrieving documents matching the words or text by using an indexing feature. A “query” may include providing a field, a value, or a pattern and retrieving documents from the database warehouse 10 matching the provided field, value, and/or pattern. The search/query 23, which need not be a single operation, may be performed as a query, may be performed as a search, may be performed as a search and a query sequentially, or either or both of the search and query may be repeated as needed.

The objective of the search is to identify and select an industry given one or more companies that represent that industry; and then to find related companies by looking across structured and unstructured fields for common characteristics that patents assigned to the companies may share. Examples of structured features in a patent may include: name of inventor, name of assignee, classification of the patent, and documents referenced by the patent. Examples of unstructured features may include regular text, such as may be found in the abstract, the claim language, or in the title of the patent or document. One or more keywords may be used that describe the selected industry. Patents and other files, either assigned to the selected companies or related to the keywords, may be extracted from the database to form a patent set, or collection, of the extracted documents from results of the search/query 23, at step 33.

A taxonomy may be generated from features and snippets most relevant to the common technology in the patent set. Snippets comprise portions of text surrounding one or more keywords of interest found in the extracted patents. The features and snippets may be used to populate a specialized “dictionary” generated from the patent set, at step 35.

The patent set may be partitioned by first assigning numeric vectors to each patent in the patent set, where the numeric vectors are the occurrences, within each patent, of the features and snippets found in the dictionary. If the term “placebo” appears in a particular patent ten times, for example, then the numeric vector for the feature “placebo” may be assigned a value of ten for the patent. Each such term may be placed into a respective category in the taxonomy. An uncategorized term may be placed into an existing category if an appropriate category exists, or into a new category if the appropriate category does not exist. This process allows for the systematic and numerical description in a feature space of each patent in the patent set, at step 37.

In an exemplary embodiment, the process of partitioning the patent set may use a “k-means” procedure, where the parameter “k” refers to the number of categories produced from the patent set. The parameter “k” may be input to the analytics tools 21 by the domain expert, or it may be generated based on the size of the patent set. The distance between a centroid of a category and a document numeric vector in the category may be expressed as a cosine distance metric

$$d ( X , Y ) = - \frac{X \cdot Y}{‖ X ‖ \cdot ‖ Y ‖}$$

where X is the centroid vector and Y is the patent numeric vector. The centroid is equivalent to the mean of the related category and may be found as part of the k-means partitioning process. A more detailed explanation of the generation of feature spaces and taxonomy generation may be obtained from commonly-assigned U.S. Pat. No. 6,424,971, “System and method for interactive classification and analysis of data.”

Domain knowledge may be used to edit the feature space taxonomy by using a domain expert to filter out noise (i.e., extraneous data) and to refine the set of terms comprising the taxonomy, at step 39. The feature space taxonomy can be edited, for example, by deleting a taxonomy category determined to be trivial, by merging two or more similar taxonomy categories into a single category, and/or by creating a new taxonomy category. Each of the patents in the patent set may thus be classified using the resulting categories created in the feature space taxonomy.

In an exemplary embodiment, a two-dimensional matrix, denoted here as a “contingency table,” may be created, at step 41, by matching the relevant taxonomy categories with the extracted patents. Match results may be summarized in tabular form from which potential partnering opportunities in a particular industry may be identified, at step 43. This can be done, for example, by using domain expertise to analyze the matrix, to examine the match results, and to identify potential white space opportunities in categories having few or no related patents.

The above methodology and analytics tools may be described in greater detail by illustrating how the disclosed method can be used to identify potential licensee markets in the pharmaceutical industry. The analytical search/query 23 may be initiated by using names from an initial list of assignees in the pharmaceutical industry. This can be done via searches or queries to retrieve patents owned by the companies found in the initial list of assignees. The search/query activity may also determine text features commonly found in the retrieved patents, such as patent classification classes and/or frequent terms or words appearing in the retrieved patents. One or more subsequent search/queries may be conducted using the commonly-found text features to retrieve a secondary tier of patents. Accordingly, additional assignees may be found in the secondary tier of patents. It should be understood that the disclosed method can be practiced by using any assignee or set of assignees in a related industry, or by using any set of keywords related to a given industry.

The analytical search/query 23 may be made to the world wide patent database 11 and directed to pharmaceutical patents and to the assignees of the pharmaceutical patents in the data warehouse 10. The analytical search/query 23 may produce a listing of eight major pharmaceutical companies, listed in Table 1.

TABLE 1
Search Results for Pharmaceutical
Company Patents

| | Assignee | Size |
|---|---|---|
| 1 | Amgen | 462 |
| 2 | AstraZeneca | 444 |
| 3 | Bristol-Meyers | 2022 |
| 4 | Genentech | 2930 |
| 5 | Johnson & Johnson | 179 |
| 6 | Merck | 5920 |
| 7 | Novartis | 9853 |
| 8 | Pfizer | 3373 |
| 9 | Miscellaneous | 8 |
| Total | | 25191 |

The column headed “size” provides the number of patents extracted from the data warehouse 10 and assigned to the respective company. The patents listed in Table 1 may be edited to extract unstructured text information and, from the extracted text, generate a feature dictionary of terms and text features. In the present example, the entries in the feature dictionary may be clustered to create the taxonomy T₁ for the patent IP. The domain expert may initiate the process by specifying suitable and appropriate categories for the clustering operation. The feature dictionary may be reviewed for selection of words and terms most relevant to the theme of the analysis and for identifying those terms associated with multiple assignees, as shown in Table 2:

TABLE 2
Taxonomy Based on Text Mining of
Patents

| | Cluster Name | Size |
|---|---|---|
| 1 | Alzheimer | 231 |
| 2 | anti-inflammatory | 279 |
| 3 | arthritis | 159 |
| 4 | asthma | 373 |
| 5 | breast | 17 |
| 6 | cancer | 442 |
| 7 | cardiovascular | 297 |
| 8 | cartilage | 33 |
| 9 | coding_sequence | 1750 |
| 10 | colon | 25 |
| 11 | delivery | 293 |
| 12 | dna | 814 |
| 13 | gastrointestinal | 262 |
| 14 | gene | 324 |
| 15 | growth hormone | 195 |
| 16 | heart | 293 |
| 17 | immune | 115 |
| 18 | kinase | 81 |
| 19 | liver | 78 |
| 20 | lung | 112 |
| 21 | pain | 186 |
| 22 | rheumatoid | 82 |
| 23 | stroke | 119 |
| 24 | tumor | 283 |
| 25 | vaccine | 100 |
| 26 | vascular | 105 |
| 27 | virus | 140 |
| 28 | miscellaneous | 18047 |
| Total | | 25175 |

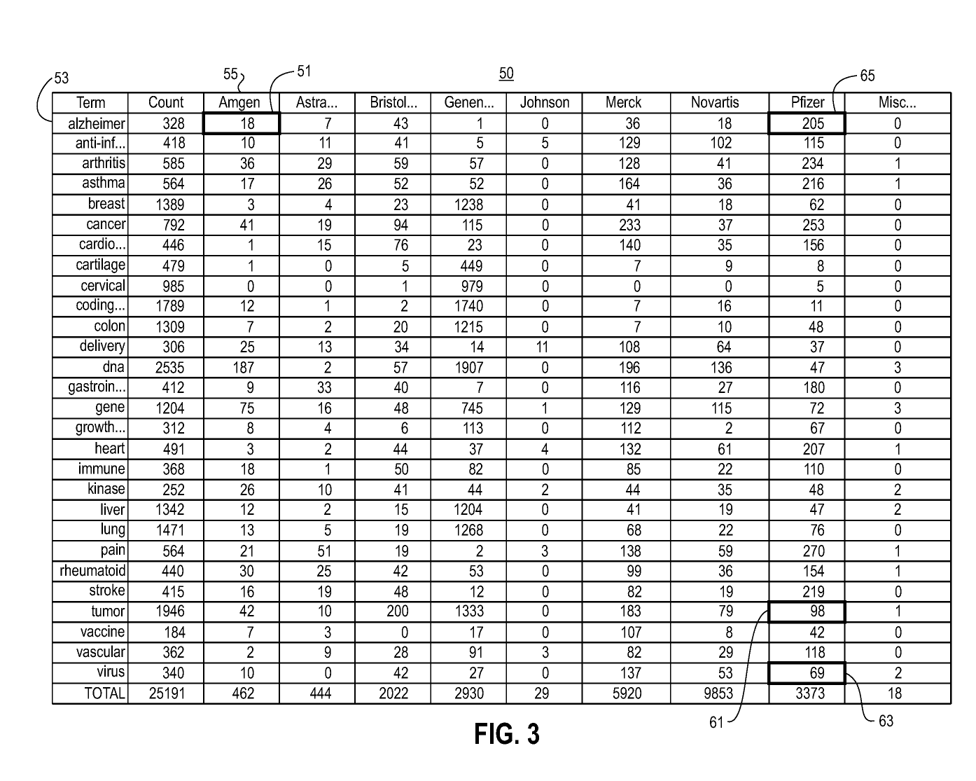

Once the taxonomy T₁ has been generated, one or more contingency tables can be constructed having a separate taxonomy entry for each row, a separate assignee identifying each column, such as a contingency table 50 shown in FIG. 3. The value entered in a cell, defined by the intersection of a row and a column, indicates the number of documents having the taxonomy term of the row for the assignee of the column. For example, a cell 51 located at the intersection of a row 53 labeled “alzheimer” and of a column 55 labeled “Amgen” has a value of “18.” That is, eighteen of the patent documents assigned to Amgen include the term “alzheimer.”

In an exemplary embodiment, a cell may be distinguished by highlighting or by rendering in a particular color to more distinctly indicate to a domain expert that the value in the cell may exceed a threshold value. The threshold value may be specified as a nominal or an average value derived by multiplying the document count, in the cell row, by a fraction equal to the total number of documents in the contingency table assigned to the assignee in the cell column divided by the total number of documents in the contingency table. For example, a cell 61 shows that ninety eight (98) documents assigned to Pfizer include the term “tumor.” A threshold value for the cell 61 may be found by multiplying the total number of “tumor” documents (i.e., 1946) by the fraction 0.134 (i.e., 3373/25191) to yield a value of two hundred sixty (260) documents. The value in the cell 61 is thus lower than this threshold value (260) and, accordingly, the cell 61 would not be highlighted or rendered in a color.

In comparison, the value for a cell 63 is sixty nine (69), which is greater than the threshold value of forty six (i.e., 340×0.134). The cell 63 may be rendered in a first color indicating a value greater than threshold. The value for a cell 65 is two hundred five (205), which is significantly greater than the threshold value of forty four (44). The cell 65 may be rendered in a second color indicating a value much greater than threshold. The color rendering may thus indicates the degree of significance of the value of the respective cell. A degree of significance may be quantitively determined, for example, by using a statistical test such as “chi-squared.” The color rendering may indicate a significant relationship between the assignee and the respective taxonomy term. As stated above, certain cells having significant correlation may be highlighted in various colors for ease of interpretation by the domain expert.

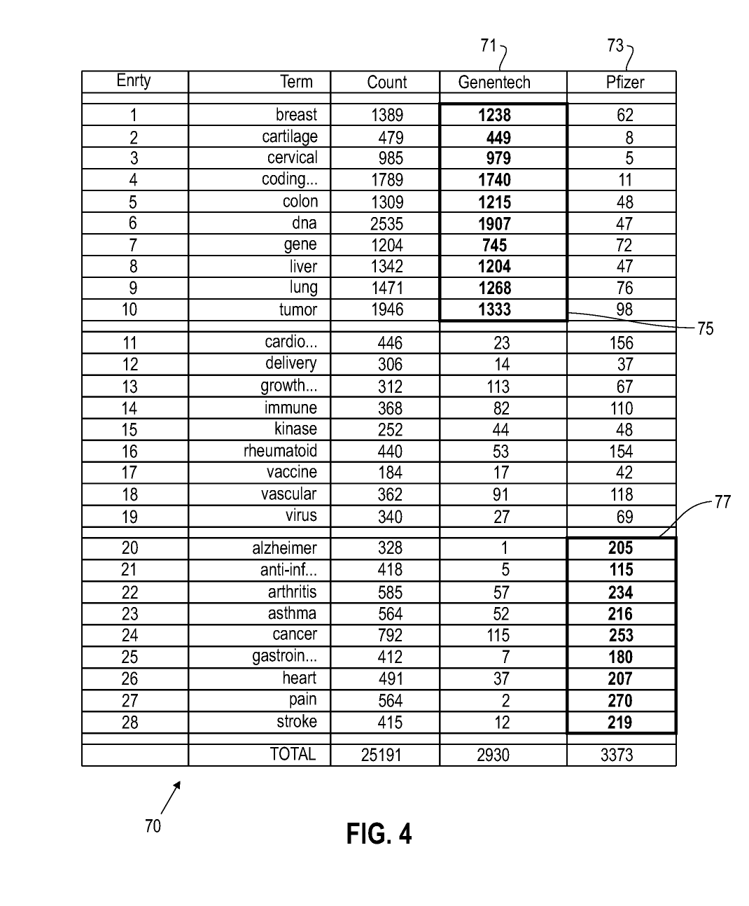

With such cell highlighting or color rendering, pairs or groups of assignees may be compared to find those that have the fewest IP overlaps. In FIG. 4, for example, a modified contingency table 70 includes the entries for only two assignees. Column 71 includes the taxonomy entries for Genentech, and column 73 includes the taxonomy entries for Pfizer. Entries in rows 1-10 indicate significant patent activity for Genentech, as indicated by a box 75. Similarly, entries in rows 20-28 indicate significant patent activity for Pfizer, as indicated by a box 77. In an exemplary embodiment, the cells enclosed by the boxes 75 and 77 may be highlighted or rendered in specific colors for ease in identification when included in the table 50, of FIG. 2. It can be appreciated from the table 70 in FIG. 3 that Genentech and Pfizer may have very few overlaps in the areas of significant patent activity, and may thus qualify as potential partners for cross-licensing or joint research.

It can be appreciated by one skilled in the art that the invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It should be understood, of course, that the foregoing relates to exemplary embodiments of the invention and that modifications may be made without departing from the spirit and scope of the invention as set forth in the following claims.

1. A method for use with a set of intellectual property documents related to an industry of interest, the method comprising:
identifying an industry of interest,
performing at least one of a search operation and a query operation among a plurality of databases that include documents and/or information about documents relevant to said identified industry of interest utilizing at least one of a value, a phrase, a pattern, a keyword or predefined subject matter entered into a structured or a non-structured field to identify a set of intellectual property documents related to said identified industry of interest, wherein said set of intellectual property documents is selected from the group consisting of: patents, trademarks, copyrights, and trade secrets;
retrieving said identified intellectual property documents matching said keywords or predefined subject matter;
classifying said the documents in the set of intellectual property documents by assignee;
creating categories for said intellectual property documents, said categories identified by at least one of terms associated with said industry of interest and features within said documents that include at least one of words, phrases, structured values, and annotations;
refining said categories to delete or merge into another category categories failing to satisfy a desired level;
providing an indication of those features within a category having greater occurrence in said intellectual property documents of said identified industry of interest,
assigning each of said intellectual property documents to at least one of said categories;
constructing a contingency table that includes a listing of assignees with respect to each of said categories, wherein a value associated with an assignee and category represents a number of intellectual property documents matching said corresponding assignee and category,
providing an indication of said values exceeding a threshold value, said threshold being determined as a function of a number of intellectual property documents associated with a category, a number of intellectual property documents associated with an assignee and a total number of intellectual property documents, wherein said indication is further adjusted based on a level of exceeding said threshold value:
ordering said contingency table based on said indication of said values exceeding a threshold value for each of said assignees;
comparing at least two of said assignees with respect to said categories;
deriving an indication of partnering potential between said at least two assignees, wherein partnering potential is determined by those of said assignees having complementary intellectual property documents that are substantially non-overlapping with respect to said categories; and
making said indication available to a user.

2-21. (canceled)
